(19) United States
(12) Patent Application Publication
(10) Pub. No.: US 2011/0132483 A1
(43) Pub. Date: Jun. 9, 2011

(54) THREE-WAY PROPORTIONAL CONTROL VALVE FOR ACTIVELY CONTROLLING COOLANT AND PROPORTIONAL CONTROL METHOD USING THE SAME

(75) Inventors: Hark Koo Kim, Yongin (KR); Seung Yong Lee, Yongin (KR)

(73) Assignee: HYUNDAI MOTOR COMPANY, Seoul (KR)

(21) Appl. No.: 12/835,260

(22) Filed: Jul. 13, 2010

(30) Foreign Application Priority Data
Dec. 4, 2009 (KR) 10-2009-0119476

(51) Int. Cl. F16K 11/00; F16K 31/02

(52) U.S. Cl. 137/625; 251/129.15

(57) ABSTRACT

The present invention provides a three-way proportional control valve for actively controlling coolant and a proportional control method using the same. The three-way proportional control valve according to the present invention may preferably include a valve body including a pump port, through which coolant is introduced, and a radiator port and a bypass port, through which the coolant is discharged; a valve spool which linearly reciprocates on a valve path formed inside the valve body and opens and closes the radiator port and the bypass port; and a solenoid mounted on the valve body and pushing the valve spool such that the radiator port is opened and the bypass port is closed when electrical power is applied thereto.

### CROSS-REFERENCE TO RELATED APPLICATION

This application claims under 35 U.S.C. §119(a) the benefit of Korean Patent Application No. 10-2009-0119476 filed Dec. 4, 2009, the entire contents of which are incorporated herein by reference.

### BACKGROUND

(a) Technical Field

The present disclosure relates to a three-way proportional control valve. More particularly, it relates to a three-way proportional control valve for actively controlling coolant and a proportional control method using the same, which can actively control the temperature of a radiator and that of a fuel cell stack.

(b) Background Art

A fuel cell system generates electrical energy by electrochemically converting chemical energy derived from fuel directly into electrical energy by oxidation of the fuel.

A typical fuel cell system comprises a fuel cell stack for generating electricity by an electrochemical reaction, a hydrogen supply system for supplying hydrogen as fuel to the fuel cell stack, an oxygen (air) supply system for supplying oxygen-containing air as an oxidant required for the electrochemical reaction in the fuel cell stack, a thermal management system (TMS) for removing reaction heat from the fuel cell stack to the outside of the fuel cell system, a controlling operation temperature of the fuel cell stack, and performing water management function, and a system controller for controlling overall operation of the fuel cell system. Preferably, the fuel cell system generates electricity by the electrochemical reaction of hydrogen and oxygen and discharges heat and water as reaction by-products.

It is important to efficiently remove heat generated during the electricity generation and maintain an optimal temperature such that the fuel cell stack, which generates electricity in the fuel cell system as a main power source of a fuel cell vehicle, obtains an optimal output.

To this end, coolant is suitably introduced into the fuel cell stack, and the coolant introduced into the fuel cell stack is circulated through the fuel cell stack to cool the fuel cell stack by absorbing the heat generated by the fuel cell stack and is then suitably discharged at a raised temperature.

Preferably, the coolant circulated through the fuel cell stack is suitably transferred to a radiator to be cooled by heat-exchange with the outside air and is then returned to the fuel cell stack.

FIG. 1 is a schematic diagram of a conventional three-way valve for controlling coolant, and FIG. 2 is a cross-sectional view of FIG. 1.

Preferably, the conventional three-way valve shown in FIG. 1 is operated by driving a stepping motor 50 to control the flow of coolant. The output of the stepping motor 50 is transferred to a valve rotating shaft 11 through a decelerator 60 to rotate the valve rotating shaft 11. Then, a valve drive unit 12 is rotated by the rotation of the valve rotating shaft 11 to open and close a radiator port 30 and a radiator bypass port 40, thus controlling the flow of coolant.

That is, the flow of coolant introduced through a pump port 20 is suitably divided according to the rotational angle of the valve drive unit 12.

Further, a separate angle sensor is provided to detect the position of the valve drive unit 12 when the power is cut off during operation.

However, since the conventional three-way valve is operated by the stepping motor 50 or a BLDC motor, it is necessary to suitably employ the decelerator 60. That is, the conventional three-way valve has problems in that the manufacturing cost is high due to the use of the motor 50 and the decelerator 60.

Moreover, the valve drive unit 12 is suitably fixed in a certain position when the power is cut off during the operation of the valve and is not automatically returned to its original position.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a three-way proportional control valve for actively controlling coolant and a proportional control method using the same, which can actively control the flow of coolant based on the temperature of a radiator and that of a fuel cell stack.

In a preferred aspect, the present invention provides a three-way proportional control valve for actively controlling coolant, the three-way valve preferably including a valve body including a pump port, through which coolant is suitably introduced, and a radiator port and a bypass port, through which the coolant is suitably discharged; a valve spool which linearly reciprocates on a valve path formed inside the valve body and opens and closes the radiator port and the bypass port; and a solenoid mounted on the valve body and pushing the valve spool when electrical power is applied thereto such that the radiator port is suitably opened and the bypass port is suitably closed.

In another aspect, the present invention provides a proportional control method for actively controlling coolant using the above described three-way valve, the method preferably including suitably detecting the temperature of the fuel cell stack; suitably detecting the temperature of the radiator; suitably determining whether to apply electrical power to the solenoid by comparing the detected temperature of the fuel cell stack with a reference temperature of the fuel cell stack; and suitably determining the amount of current supplied to the solenoid by comparing the detected temperature of the radiator with a reference temperature of the radiator.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram of a conventional three-way valve for controlling coolant.

FIG. 2 is a cross-sectional view of FIG. 1.

FIG. 3 is a perspective view of a three-way proportional control valve for actively controlling coolant in accordance with an exemplary embodiment of the present invention.

FIGS. 4A and 4B are cross-sectional views of the three-way proportional control valve of FIG. 3.

FIG. 5 is a cross-sectional view taken along line A-A of FIG. 4A.

FIG. 6 is a cross-sectional view showing a state in which a solenoid is operated such that a valve spool is moved to close a radiator port.

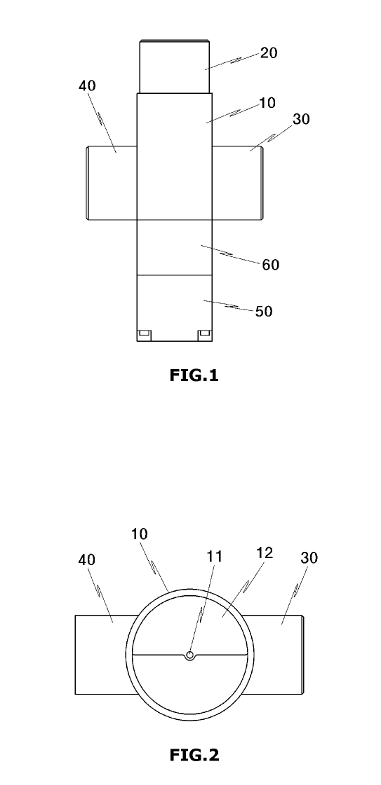

Reference numerals set forth in the Drawings includes reference to the following elements as further discussed below:

| | |
|---|---|
| 100: valve body | 101: valve path |
| 110: pump port | 120: radiator port |
| 130: radiator bypass port | 140: solenoid |
| 141: solenoid coil | 142: solenoid plunger |
| 143: solenoid core | 144: solenoid shaft |
| 145: solenoid cap | 146: O-ring |
| 147: insulator | 148: solenoid body |
| 149: solenoid coil connector | 150: valve spool |
| 160: control spring | 161: spring cover |
| 163: waterproof pad | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

As described herein, the present invention features a three-way proportional control valve for actively controlling coolant, the three-way valve comprising a valve body comprising a pump port, a radiator port and a bypass port, a valve spool, and a solenoid mounted on the valve body and pushing the valve spool when electrical power is applied thereto.

In one embodiment, coolant is introduced through the pump port.

In another embodiment, coolant is discharged through the radiator port and the bypass port.

In another further embodiment, the valve spool linearly reciprocates on a valve path formed inside the valve body and opens and closes the radiator port and the bypass port.

In still another further embodiment, the solenoid pushes the valve spool when electrical power is applied thereto such that the radiator port is opened and the bypass port is closed.

The invention also features a proportional control method for actively controlling coolant using the three-way valve of claim 1, the method comprising detecting the temperature of the fuel cell stack, detecting the temperature of the radiator, determining whether to apply electrical power to the solenoid by comparing the detected temperature of the fuel cell stack with a reference temperature of the fuel cell stack; and determining the amount of current supplied to the solenoid by comparing the detected temperature of the radiator with a reference temperature of the radiator.

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

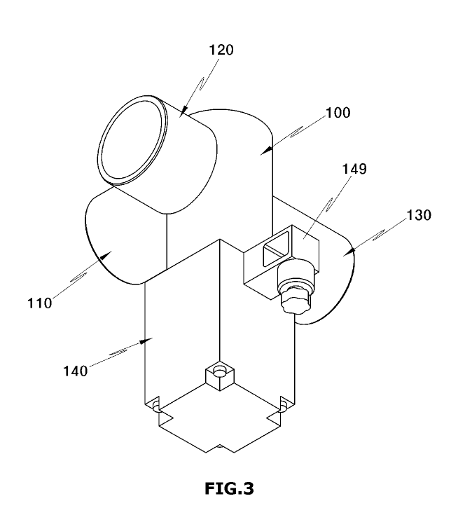

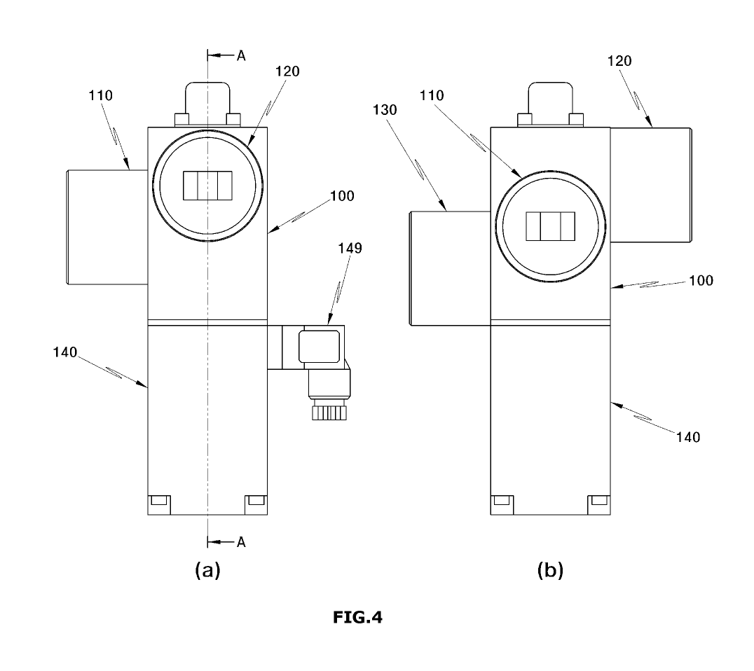

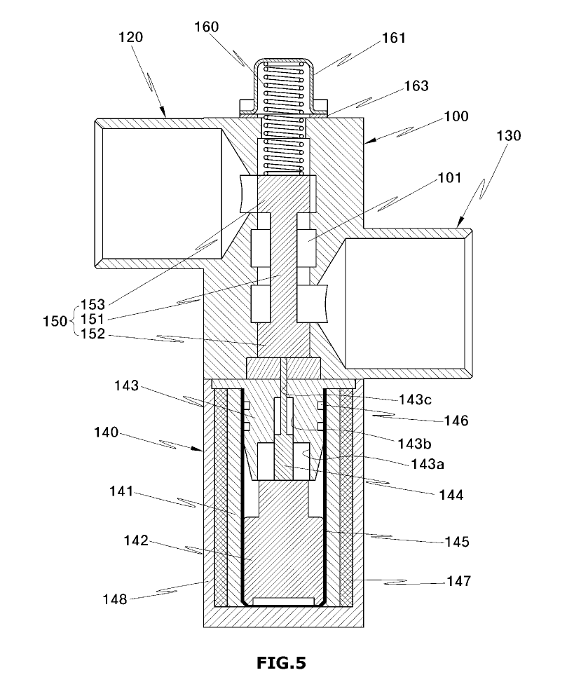

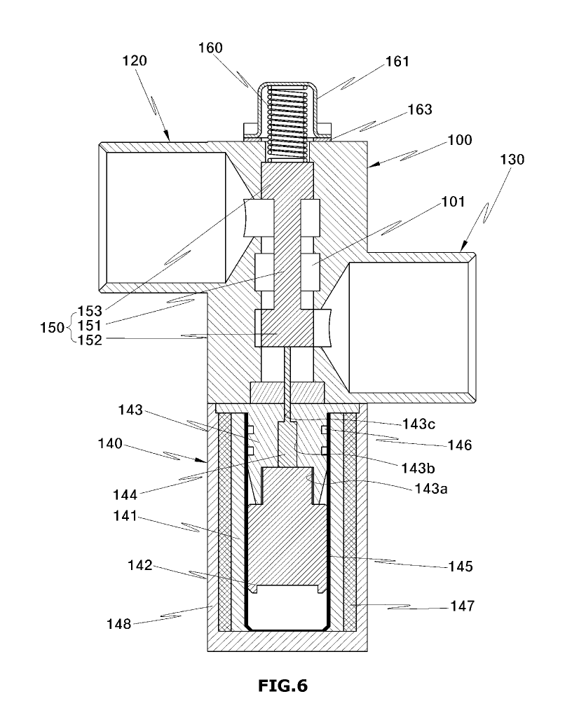

According to certain preferred embodiments and as shown in FIGS. 3-6, for example, FIG. 3 is a perspective view of a three-way proportional control valve for actively controlling coolant in accordance with an exemplary embodiment of the present invention, FIGS. 4A and 4B are cross-sectional views of the three-way proportional control valve of FIG. 3, FIG. 5 is a cross-sectional view taken along line A-A of FIG. 4A, and FIG. 6 is a cross-sectional view showing a state in which a solenoid is operated such that a valve spool is moved to close a radiator port.

According to certain preferred embodiments, the three-way proportional valve of the present invention is suitably configured to control the movement of a valve spool 150, which linearly reciprocates on a valve path 101 suitably formed inside a valve body 100, to control the flow of coolant to two output ports such as a radiator port 120 and a radiator bypass port 130 (hereinafter referred to as a bypass port). Preferably, drive means for controlling the linear movement of the valve spool 150 includes a solenoid 140 and a control spring 160.

According to preferred embodiments of the present invention, when a current is suitably applied to a solenoid coil 141 (hereinafter referred to as a coil) through a solenoid coil connector 149 of the solenoid 140, a solenoid plunger 142 (hereinafter referred to as a plunger) enters the inside of a solenoid core 143 (hereinafter referred to as a core) to push the valve spool 150 to be moved.

Accordingly, to this end, the solenoid 140 preferably includes a solenoid body 148 detachably connected to the valve body 100, the coil 141 inserted into the solenoid body 148, and the plunger 142 and the core 143 surrounded by a solenoid cap 145 that is suitably disposed inside the coil 141.

Preferably, the solenoid body 148 with an opened upper end has a hollow rectangular shape, and the plunger 142 preferably includes a magnet, and the core 143 includes an electromagnet.

Accordingly, when a current flows through the coil 141, the core 143 is suitably magnetized to serve as a magnet. In a preferred exemplary embodiment of the present invention, the core 143 has a polarity that is different from that of the plunger 142, thus causing gravity.

Preferably, since the core 143 is detachably fixed to the lower end of the valve body 100, the plunger 142 enters a first groove 143a formed at the lower end of the core 143 (which faces the plunger 142) to suitably push the valve spool 150 to be moved.

To this end, a solenoid shaft 144 detachably connected to the valve spool 150 is suitably mounted at the upper end of the plunger 142. Moreover, a second groove 143b, extending from the first groove 143a, and a through-hole 143c are suitably formed in the core 143.

According to certain preferred embodiments, the solenoid shaft 144 has a stepped structure in which the diameter of the upper end is smaller than that of the lower end and, while the plunger 142 does not enter the first groove 143a of the core 143, a part of the lower end of the solenoid shaft 144 enters the second groove 143b of the core 143.

Further, the solenoid 140 preferably includes an insulator 147 for insulating between the coil 141 and the solenoid body 148, and a pair of O-rings 146 for preventing coolant from leaking are suitably disposed between the solenoid cap 145 and the core 143.

Meanwhile, the valve body 100 preferably includes a pump port 110 as an input port, through which the coolant is suitably introduced, and the radiator port 120 and the bypass port 130, through which the coolant is suitably discharged as mentioned above.

Preferably, the pump port 110, the radiator port 120, and the bypass port 130 extend horizontally in different directions and form a right angle with each other.

According to certain preferred embodiments, the valve path 101 connected to the pump port 110, the radiator port 120, and the bypass port 130 is suitably formed inside the valve body 100, and the valve spool 150 is suitably inserted into the valve path 101 and movably installed.

According to certain preferred embodiments, the valve spool 150 preferably includes a pair of blocking portions 152 and 153 and an opening portion 151, which have different diameters. Preferably, the blocking portions 152 and 153 are provided at both sides of the opening portion 151 formed in the center of the valve spool 150. Accordingly, the coolant introduced through the pump port 110 having a relatively small diameter flows on the outside of the opening portion 151, and the radiator port 120 or the bypass port 130 is suitably closed by the blocking portions 152 and 153 having a relatively large diameter.

Therefore, the flow path of the coolant is suitably determined according to the position of the valve spool 150 as shown in FIGS. 5 and 6.

Preferably, the control spring 160 penetrating the upper end of the valve body 100 is suitably configured to be in contact with the blocking portion 153 of the valve spool 150, and a spring cover 161 is suitably provided to protect the upper end of the control spring 160, which partially projects to the outside of the valve body 100, and to suitably support the control spring 160 when it contracts.

Preferably, the spring cover 161 is connected to the upper end of the valve body 100 with a waterproof pad 163 interposed therebetween.

Therefore, the three-way valve according to preferred embodiments of the present invention operates in the following manner.

According to certain exemplary embodiments, the solenoid 140 does not operate when no current is applied to the coil 141, as shown in FIG. 5, and thus the valve spool 150 is pushed toward the solenoid 140 by the spring force of the control spring 160 to close the radiator port 120, which allows the coolant to flow through the bypass port 130.

In other further exemplary embodiments, the solenoid 140 operates when the current is suitably applied to the coil 141, for example as shown in FIG. 6, and thus the plunger 142 is moved upward by the gravity between the core 143 and the plunger 142 to close the bypass port 130, which allows the coolant introduced through the pump port 110 to flow through the radiator port 120.

According to further exemplary embodiments, if the current supply to the coil 141 of the solenoid 140 is cut off in a state as shown in FIG. 6, the spring force of the control spring 160 pushes the valve spool 150 toward the solenoid 140 such that the valve spool 150 is automatically returned to its original position (where the blocking portion 153 of the valve spool 150 closes the radiator port 120 as shown in FIG. 5).

According to other further embodiments, the three-way valve according to the present invention can suitably control the amount of coolant flowing through both the radiator port 120 and the bypass port 130 by suitably controlling the movement of the valve spool 150 according to the current supplied to the solenoid 140 to control the opening degrees of the radiator port 120 and the bypass port 130.

Accordingly, the three-way valve according to the present invention suitably controls the amount of coolant flowing through the radiator port 120 and the bypass port 130 according to the current supplied to the solenoid 140, and thus it is possible to actively control the temperature of the fuel cell stack by suitably detecting the temperature of the fuel cell stack and that of the radiator.

Preferably, the temperature of the fuel cell stack and that of the radiator are suitably detected based on the temperature of coolant. According to further preferred embodiments, the temperature of the fuel cell stack is suitably detected based on the temperature of the coolant discharged from the fuel cell stack, and the temperature of the radiator is suitably detected based on the temperature of the coolant introduced into the radiator.

A proportional control method for actively controlling coolant using the three-way valve according to preferred embodiments of the present invention is described.

According to preferred embodiments of the present invention, a controller (not shown) detects the temperature of the fuel cell stack and that of the radiator using two temperature sensors to actively control the temperature of the fuel cell stack. Preferably, in certain embodiments, the controller receives a reference temperature of the fuel cell stack from a superior controller and compares it with the current temperature of the fuel cell stack.

Accordingly, if the temperature of the fuel cell stack is higher than the predetermined temperature, electrical power is suitably applied to the solenoid 140 to open the radiator port 120 such that the coolant cooled in the radiator is suitably circulated through the fuel cell stack, thus maintaining the temperature of the fuel cell stack constant. According to other further preferred embodiments, if the temperature of the fuel cell stack is lower than the reference temperature of the fuel cell stack, the power supply to the solenoid 140 is cut off to open the bypass port 130 such that the coolant is not passed through the radiator but flows through the fuel cell stack via the bypass port 130.

Further, the controller suitably controls the amount of coolant flowing through the radiator to suitably control the amount of heat dissipated from the coolant by comparing the detected temperature of the radiator with a reference temperature of the radiator received from the superior controller.

According to other further preferred embodiments, if the current temperature of the radiator is suitably higher than the reference temperature of the radiator, the intensity of current applied to the solenoid 140 is suitably increased to increase the movement of the valve spool 150 (toward the control spring 160), thereby suitably increasing the amount of coolant flowing through the radiator. According to other embodiments of the invention, if the current temperature of the radiator is lower than the reference temperature of the radiator, the intensity of current applied to the solenoid 140 is suitably reduced to reduce the movement of the valve spool 150, thereby reducing the amount of coolant flowing through the radiator.

Preferably, the controller determines whether to apply electrical power to the solenoid 140 based on the temperature information of the fuel cell stack and suitably controls the movement of the valve spool 150 based on the temperature information of the radiator, thereby controlling the amount of coolant flowing through the radiator port 120 and the bypass port 130.

According to certain preferred embodiments, when the vehicle operation is suitably stopped during the operation of the three-way valve according to the present invention, the valve spool 150 is fixed to open the bypass port 130 by the spring force of the control spring 160, which is advantageous especially in winter.

As described herein, the present invention provides the following effects.

Since the amount of coolant flowing through the radiator port and the bypass port is controlled by the proportional control solenoid valve, the three-way valve has a simple structure.

Further, it is possible to actively control the temperature of the fuel cell stack and that of the radiator by suitably detecting the temperature of the coolant discharged from the fuel cell stack and that of the coolant introduced into the radiator.

Furthermore, since the valve spool can be automatically returned to its original portion when the power is cut off, it is possible to determine the position of the valve spool.

Therefore, it is possible to eliminate the motor, the decelerator, and the valve position detection sensor, which are suitably employed in the existing three-way valve, and thus it is possible to reduce the manufacturing cost and the weight of the three-way valve.

The present invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A three-way proportional control valve for actively controlling coolant, the three-way valve comprising:
a valve body including a pump port, through which coolant is introduced, and a radiator port and a bypass port, through which the coolant is discharged;
a valve spool which linearly reciprocates on a valve path formed inside the valve body and opens and closes the radiator port and the bypass port; and
a solenoid mounted on the valve body and pushing the valve spool when electrical power is applied thereto such that the radiator port is opened and the bypass port is closed.

2. The three-way valve of claim 1, further comprising a control spring mounted on the valve body to move the valve spool such that the radiator port is closed when the power supply to the solenoid is cut off.

3. The three-way valve of claim 1, wherein the solenoid comprises:
a solenoid body;
a coil mounted inside the solenoid body;
a plunger including a solenoid shaft detachably connected to the valve spool and mounted inside the coil;
a core generating a magnetic force when a current flows through the coil to pull the plunger toward the valve spool; and
a solenoid cap inserted into the coil and surrounding the core and the plunger.

4. A proportional control method for actively controlling coolant using the three-way valve of claim 1, the method comprising:
detecting the temperature of the fuel cell stack;
detecting the temperature of the radiator;
determining whether to apply electrical power to the solenoid by comparing the detected temperature of the fuel cell stack with a reference temperature of the fuel cell stack; and
determining the amount of current supplied to the solenoid by comparing the detected temperature of the radiator with a reference temperature of the radiator.

5. The method of claim 4, wherein the step of determining whether to apply electrical power to the solenoid comprises:
applying electrical power to the solenoid if the detected temperature of the fuel cell stack is higher than the reference temperature of the fuel cell stack; and
cutting off the power supply to the solenoid if the detected temperature of the fuel cell stack is lower than the reference temperature of the fuel cell stack.

6. The method of claim 4, wherein the step of determining of the amount of current supplied to the solenoid comprises:
increasing the amount of current supplied to the solenoid to increase the movement of the valve spool if the detected temperature of the radiator is higher than the reference temperature of the fuel cell stack; and
reducing the amount of current supplied to the solenoid to reduce the movement of the valve spool if the detected temperature of the radiator is lower than the reference temperature of the fuel cell stack.

7. A three-way proportional control valve for actively controlling coolant, the three-way valve comprising:
a valve body comprising a pump port, a radiator port and a bypass port;
a valve spool; and
a solenoid mounted on the valve body and pushing the valve spool when electrical power is applied thereto.

8. The three-way proportional control valve of claim 7, wherein coolant is introduced through the pump port.

9. The three-way proportional control valve of claim 7, wherein coolant is discharged through the radiator port and the bypass port.

10. The three-way proportional control valve of claim 7, wherein the valve spool linearly reciprocates on a valve path formed inside the valve body and opens and closes the radiator port and the bypass port.

11. The three-way proportional control valve of claim 7, wherein the solenoid pushes the valve spool when electrical power is applied thereto such that the radiator port is opened and the bypass port is closed.
